(19) United States
(12) Patent Application Publication
(10) Pub. No.: US 2026/0053302 A1
(43) Pub. Date: Feb. 26, 2026

(54) DRYING TOWEL

(71) Applicant: Dan Paul Boyer-Schneider, Torrance, CA (US)

(72) Inventor: Dan Paul Boyer-Schneider, Torrance, CA (US)

(21) Appl. No.: 19/221,210

(22) Filed: May 28, 2025

Related U.S. Application Data
(60) Provisional application No. 63/652,572, filed on May 28, 2024.

(51) Int. Cl. A47K 10/02; B32B 3/26; B32B 5/02; B32B 7/12

(52) U.S. Cl. CPC A47K 10/02; B32B 3/266; B32B 5/024; B32B 7/12; B32B 2262/0261; B32B 2262/0276; B32B 2307/718; B32B 2307/726; B32B 2307/7376; B32B 2432/00

(57) ABSTRACT

Drying towels comprise an upper outer material layer formed from a fiber-containing material that is adhered to an upper surface of an inner absorbent material layer. The inner absorbent material layer may comprise one or more surface features that may be openings or grooves. The drying towel includes a lower outer material layer formed from a fiber-containing material that is adhered to a lower surface of the inner absorbent material layer. The inner absorbent material layer upper and lower surface may be covered by the respective upper and lower material layers sandwiching or encapsulating the inner absorbent material layer therebetween. An adhesive material may adhere the upper and lower material layers to the inner adhesive material layer and form a laminate construction. An edging material may be attached along a peripheral edge of the drying towel and cover peripheral ends of the upper and lower outer material layers.

### CROSS-REFERENCE TO RELATED APPLICATIONS

This application claims the benefit of U.S. Provisional Application No. 63/652,572 filed May 28, 2024, which is herein incorporated by reference in its entirety.

### FIELD

Disclosed herein are devices, systems, and/or methods relating to drying towels or pads and, more particularly, the construction and fabrication of drying towels or pads specially engineered to have an improved degree of liquid absorption and retention when compared to convention drying towels or pads.

### BACKGROUND

The use of towels or pads to remove liquid such as water or the likes from the surface of a substrate such a surface of a vehicle, e.g., a car, is known and such towels or pads conventionally used for this purpose have a unitary construction in that they are made from a single material. For example, conventional fabric or fiber towels include those made from cotton and/or synthetic materials or the like are known to be used for this purpose, e.g., for removing water from the surface of a vehicle after it has been washed. Also, the use of natural or synthetic chamois is known to be used for such purpose.

While such conventional towels may be used for this purpose, they are typically not specifically made for removing the quantity of water associated with the relatively large surface area of a vehicle, as in most cases such conventional towels are made for drying the human body. Accordingly, when using such conventional towels to dry the surface of a vehicle the towel quickly reaches its saturation point and must be repeatedly wrung out frequently during the process, which is time consuming and labor intensive.

Additionally, depending on the type of fabric that the conventional towel is made from, there is a risk of scratching the finish, e.g., the painted finish, of the car surface during the process. Such scratching may be caused from the interface of the fabric material itself with the vehicle surface and/or may be caused if any dirt or other particle(s) is on the wetted vehicle surface, i.e., interposed between the vehicle surface and the towel, and is moved over the vehicle surface during the process of wiping the towel over the vehicle surface.

It is, therefore, desired that a towel or pad be constructed in a manner that provides an increased level or degree of liquid absorption and retention when compared to the conventional towels described above. It is further desired that such towel or pad also be constructed in a manner that minimizes or eliminates the possibility of scratching the vehicle surface during use.

### SUMMARY

Drying towels as disclosed herein generally comprise an upper outer material layer formed from a fiber-containing material, and an inner absorbent material layer. In an example, the upper outer material layer is adhered to an upper surface of the inner absorbent material layer. In an example, the absorbent material layer may be formed from a chamois material that is natural or synthetic. In an example, the inner absorbent material layer comprises one or more surface features disposed therein. In an example, the one or more surface features may comprise one or more openings extending through the inner absorbent material layer. In an example, the one or more surface features comprise more than one opening that extend across a partial width and a partial length of the inner absorbent material layer. In an example, the one or more openings may be rectangular in shape. In an example, the one or more surface features may comprise a plurality of openings that are arranged in an ordered or a random pattern. In an example, the one or more surface features may comprise one or more grooves that extend inwardly a partial depth into at least one of the upper surface or the lower surface of the inner absorbent material layer.

In an example, the drying towel further comprises a lower outer material layer formed from a fiber-containing material. The lower outer layer is adhered to a lower surface of the inner absorbent material layer. In an example, the one or more surface features may comprise one or more grooves that extend inwardly a partial depth into at least one of the upper surface or the lower surface of the inner absorbent material layer. In an example, an entirety of the inner absorbent material layer upper and lower surface may be covered by the respective upper and lower material layers sandwiching or encapsulating the inner absorbent material layer therebetween. In an example, an adhesive material may be interposed between the upper and lower inner absorbent material layer and the respective upper and lower material layers. The adhesive material may be used to adhere the upper and lower material layers to the inner adhesive material layer and form a laminate construction. In an example, the drying towel may comprise an edging material that is attached along a peripheral edge of the drying towel and the covers peripheral ends of the upper and lower outer material layers.

In an example, drying towels as disclosed herein may be made by depositing an adhesive material onto opposed surfaces of an inner absorbent material layer. The inner adhesive material may be moved towards opposed upper and lower nip rollers. An upper outer material layer may be dispensed to the upper nip roller causing the upper outer material to be compressed into contact with an upper surface of the inner absorbent material layer. A lower outer material layer is dispensed to the lower nip roller causing the lower outer material layer to be compressed into contact with a lower surface of the inner absorbent material layer thereby making the drying towel in the form of a composite construction. In an example, the upper and lower outer material layers are compressed into contact with respective upper and lower surfaces of the inner absorbent material layer at a heated temperature condition. In an example, an edging material is attached to peripheral edges of the composite construction to cover the ends of the upper and lower outer material layers. In an example, during the step of depositing, the adhesive material is applied to a substantial entirety of the opposed surfaces of the inner absorbent material layer.

Drying towels as disclosed herein are constructed in a manner that provides an increased level or degree of liquid absorption and retention when compared to the conventional towels described above.

### BRIEF DESCRIPTION OF THE DRAWINGS

These and other features and aspects of drying towel and methods of making the same as disclosed herein will be appreciated as the same becomes better understood by reference to the following detailed description when considered in connection with the accompanying drawings where:

FIG. 1 is perspective view of an example drying towel according to some embodiments of the present disclosure;

FIG. 2 is a perspective view of an example inner absorbent material layer as included in the example drying towel of FIG. 1 according to some embodiments of the present disclosure;

FIG. 3 is a perspective view of another example inner absorbent material layer as included in the example drying towel of FIG. 1 according to some embodiments of the present disclosure;

FIG. 4 is a perspective view showing different example layers of material as included in the example drying towel of FIG. 1 according to some embodiments of the present disclosure;

FIG. 5 is a schematic view of a method of making an example drying towel according to some embodiments of the present disclosure; and

FIG. 6 is a perspective view of an example inner absorbent material layer as included in an example drying towel according to some embodiments of the present disclosure.

### DESCRIPTION

Drying towels or pads as disclosed herein are generally constructed having a laminate structure comprising two opposed material outer layers with a central absorbent layer interposed therebetween. In an example, the two opposed material outer layers are made from a material different from that of the central absorbent layer. In an example, the central absorbent layer is made from a material that is more liquid absorbent than one or both of the two outer material layers. In an example, the outer material layers may be made from a material configured to minimize or eliminate the possibility of scratching a surface being contacted when using the drying towel to remove water therefrom. While drying towels or pads disclosed herein are described in the context of being used to remove liquid, water, or moisture from a surface of a vehicle, it is to be understood that such towels or pads as disclosed herein may also be used to wash the surface of a vehicle or the like, or to perform other tasks such as those routinely involving applying, removing, or moving liquid relative to a surface, e.g., a vehicle or other surface.

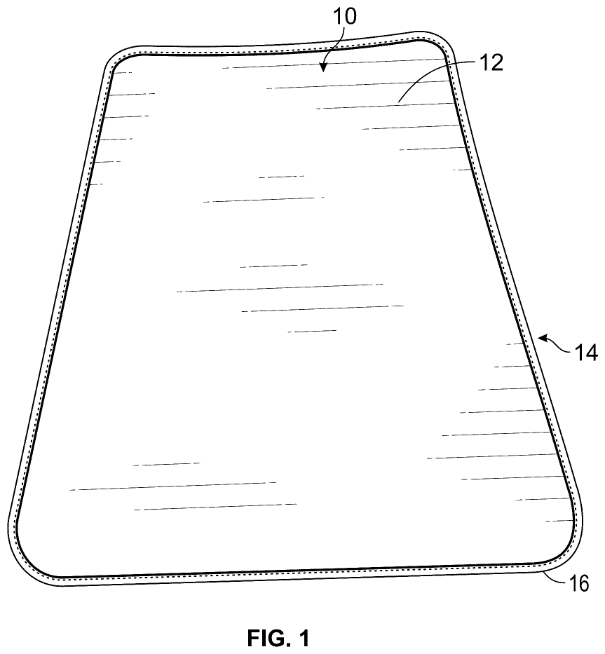

FIG. 1 illustrates an example towel or pad 10 as disclosed herein showing an upper surface of the towel that is formed from an upper outer material layer 12. The example towel or pad 10 comprises a lower surface (not shown) that is opposite the upper surface and that is formed from a lower material layer (not shown). In an example, the upper outer material layer 12 and lower material layer are combined together along a peripheral edge 14 of the towel. In an example, an edging material 16 is attached around the peripheral edge of both the upper and lower material layers closing the peripheral edge of the towel. In an example, the edging material 16 is formed from a fabric that is sewn to the upper and lower material to thereby close the towel peripheral edge. It is understood that the size of towels or pads as disclosed herein may vary depending on the particular end-use application. In an example, for purposes of reference, an example towel or pad may be sized having a length of approximately 28 inches and a width of approximately 24 inches.

In an example, one or both of the outer material layers may be made from a fiber or fabric material that is configured to reduce the possibility of scratching a finished surface that the towel is being used with. In an example, the outer material layer is made from a microfiber material that is configured to lift or pull dirt and/or debris particles away from surface it is placed in contact with. Suitable microfiber materials include those made from polyesters, polyamides, and/or a combination of these or other materials. In an example, the outer material layer is a combination of approximately 30 percent polyamide and 70 percent polyester. In an example, the microfiber material may have a fiber with less than about 1 denier per filament. An example microfiber material useful for forming the outer material layers may have a weight of greater than about 50 grams per square meter (GSM), greater than about 100 GSM, greater than about 200 GSM, from about 100 to 500 GSM, from about 200 to 300 GSM, and in a preferred embodiment have a weight of approximately 260 GSM. In an example, each outer layer material may have a thickness of greater than about 1/16 inches, from about 1/16 inches to ¼ inches, and in a preferred embodiment have a thickness of approximately 5/32 inches. In an example, the upper and lower outer layers are made of the same material and have the same thickness,

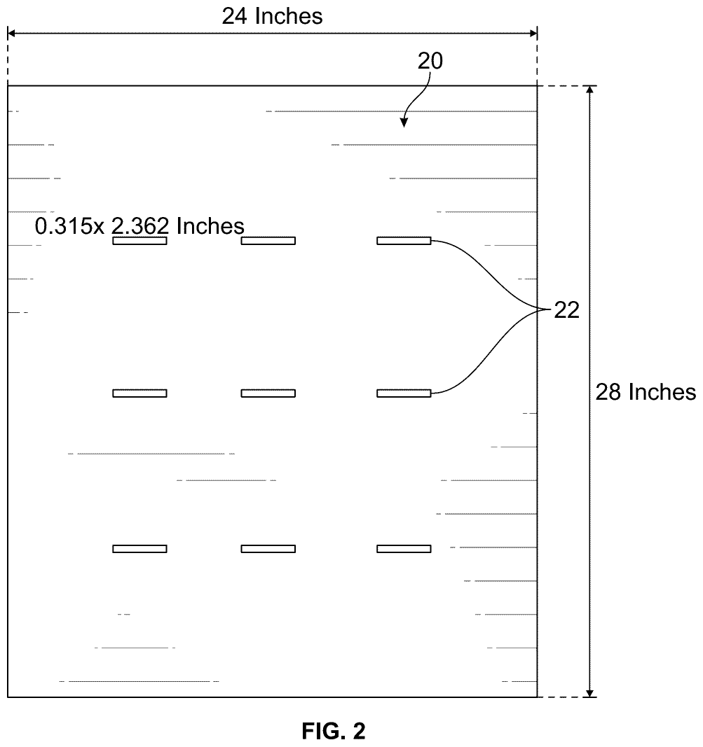

FIG. 2 illustrates an example inner absorbent material layer 20 as used in the example towel or pad as disclosed herein. In an example, the inner absorbent material layer 20 is interposed or sandwiched between the two outer material layers, thus is located in the center of the towel or pad construction. In an example, the absorbent material layer 20 is made from a material that is more liquid absorbent than the outer material layers for the purpose of pulling liquid through the outer material layers and retaining the same during use to thereby increase the overall liquid absorption of the towel to reduce the time and labor associated with having to frequently dewater or wring out the towel during use. In an example, use of the inner absorbent material layer 20 functions to reduce the amount of times that dewetting is needed during the drying of a typical car surface compared to using a conventional single-material towel or chamois. The size of the inner absorbent material layer 20 can and will vary depending on the size of the towel or pad. In an example, the inner absorbent material layer 20 is sized so that the entirety of an upper and lower surface of the inner absorbent material layer is completely covered by the respective upper and lower outer material layers, i.e., the inner absorbent material layer outer surfaces are completely sandwiched and encapsulated between the outer material layers. Thus, in the example provided above where the example towel or pad is approximately 28 inches by approximately 24 inches, the inner absorbent material layer is sized having a length of approximately 28 inches and a width of approximately 24 inches.

In an example, the inner absorbent material layer may be made from a chamois material that is natural or synthetic and that is liquid absorbent. In an example, the inner absorbent material layer is formed from 100% polyamide made of 30/70 sea-island fiber. An example inner synthetic chamois material useful for forming the outer material layers may have a weight of greater than about 50 GSM, greater than about 100 GSM, greater than about 200 GSM, from about 100 to 500 GSM, from about 200 to 300 GSM, and in a preferred embodiment have a weight of approximately 240 GSM. In an example, the absorbent material layer may have a thickness of greater than about 1/32 inches, 1/16 inches, from about 1/16 inches to ⅜ inches, and in a preferred embodiment have a thickness of approximately 1/16 inches.

In an example, the inner absorbent material layer 20 is configured comprising one or more surface features disposed along its surface. In an example, the one or more surface features comprise openings 22 disposed therethrough extending between the opposed outer surfaces. In an example, the inner absorbent material layer 20 comprises a plurality of openings 22. It is understood that the exact number and/or placement, and/or shape of the openings 22 may vary and that all such variations are understood to be within the scope of the towel or pad as disclosed herein. In an example, the openings may form pockets in the towel that may function to assist with dewetting, and/or that may enhance the attachment of the construction by providing locations in the construction where the opposed outer material layers may be bonded together, thereby providing a more robust three-layer laminate construction. In an example, the openings 22 may be rectangular in shape and may be oriented running parallel or perpendicular with the length of the inner absorbent material layer 20. In an example, the inner absorbent material layer 20 comprises rectangular openings 22 that are oriented running parallel along the width of the inner absorbent material layer 20. In an example, the inner absorbent material layer comprises two or more rows each oriented parallel with one another along the width of the inner absorbent material layer 20, wherein each row comprises two or more openings 22. In such example, the openings above or below one another define one or more columns of openings 22. In the example illustrated in FIG. 2, the inner absorbent material layer 20 comprises a 3×3 matrix of nine openings 22 including three rows of three openings and three columns of three openings. In the example disclosed above, where the inner absorbent material layer 20 size is approximately 28 inches by 24 inches, the openings 22 are each sized approximately 0.315 inches by 2.36 inches. In such example the openings 22 are spaced equidistantly apart from one another.

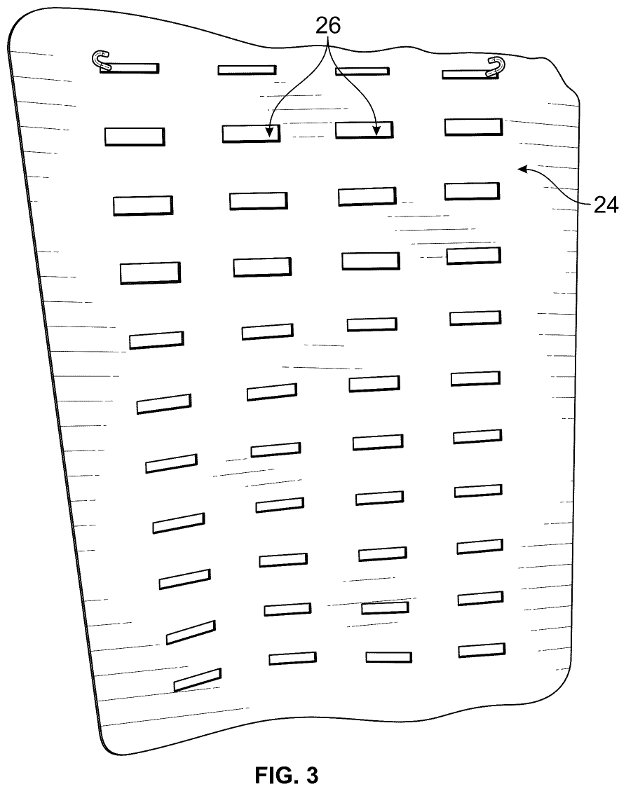

While a particular arrangement of inner absorbent material layer openings 22 has been disclosed and illustrated, it is to be understood that other arrangements, shapes, sizes, number, and/or orientation of the surface features or openings 22 that function in the manner disclosed are intended to be within the scope of towels or pads as disclosed herein. For example, FIG. 3 illustrates another example inner absorbent material layer 24 as used in the example towel or pad as disclosed herein that comprises a greater number of surface features or openings 26 each sized larger than the openings 22 disclosed above for the inner absorbent material layer 20 illustrated in FIG. 2. This is but one example of how the openings in the inner absorbent material layer may be varied in number, location, size, shape, and/or orientation and be within the scope of the towel or pad construction as disclosed herein. For example, the openings may have a shape that is not ordered but random, and/or the location and/or orientation of the openings along the inner absorbent material layer may be ordered or random.

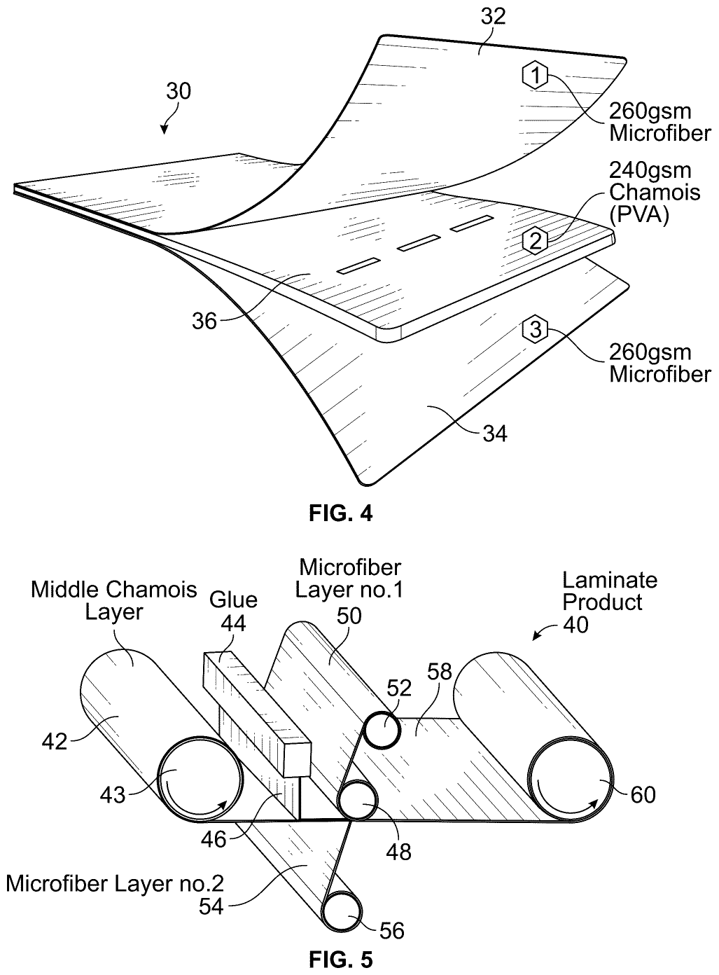

FIG. 4 illustrates an example laminate construction of the towel or pad 30 disclosed herein comprising the upper outer material layer 32, and lower material layer 34, and the inner absorbent material layer 36 interposed therebetween showing the separate layers partially apart from one another. As disclosed above, the towel or pad disposed herein is a laminate construction of the three different layers, wherein the inner absorbent material layer 36 is encapsulated or completely surrounded by the upper and lower material layers 32 and 34.

FIG. 5 illustrates an example method of fabricating the towel or pad 40 as disclosed herein. In an example, the laminate towel or pad construction is formed by dispensing the inner absorbent material layer 42 from a roller 43 and past upper and lower adhesive stations 44 that are configured to dispense an adhesive 46 onto opposed upper and lower surfaces of the inner absorbent material layer 42. In an example, the adhesive is dispensed onto an entirety of the upper and lower surfaces of the inner absorbent material layer 42. The inner absorbent material layer 42 now comprising the adhesive 46 disposed thereon is passed towards a set of opposed upper and lower nip rollers 48. The upper outer material layer 50 is dispensed from a roller 52 to the upper nip roller 48 at the same time that the lower outer material layer 54 is dispensed from a roller 56 to the lower nip roller 48, and the upper and lower outer material layers 50 and 54 are combined under pressure with respective adhesive-containing upper and lower surfaces of the inner absorbent material layer 42 by passage of all three layers through the opposed upper and lower nip rollers 48 that compresses the three layers together to form the laminate construction 58.

In an example, the three layers may be compressed together under elevated or heated temperature conditions. The resulting laminate construction is characterized by the upper and lower material layers being bonded to an entirety of the respective upper and lower inner absorbent material layer surfaces. During lamination, the openings in the inner absorbent material layer may remain open and covered by the upper and lower material layers, e.g., forming open pockets, or may comprise sections of the upper and lower material layers disposed therein that are bonded together to fill the openings. The so-formed laminate construction 58 is then passed to and wound onto a collection roller 60. Once a desired amount of the laminate construction 58 has been formed, it is removed or dispensed from the collection roller 60, cut into desired lengths, and the edging is sewn around the peripheral edge (which later steps may be performed after transporting of the bulk formed laminate construction 58 to a finishing location or the like).

In an example, the suitable adhesives used to make the laminate construction may be ones that both function to join the three material layers together, and that are permeable to water to enable water to pass between the outer material layers and the inner absorbent material layer during use of the towel or pad, e.g., during drying and dewetting use of the towel or pad. In an example, the adhesive may be a hot melt adhesive such as a polyurethane oil adhesive or other type of hot melt adhesive. In an example, the lamination process may be heated through the use of heated nip rollers or the like. In an example, the laminated construction disclosed herein may be formed by a combination of heat and compression or pressure. In an example, the laminated towel or pad construction has a total thickness of greater than about 3/16 inches, from about 3/16 to ¾ inches, and in preferred embodiment approximately 7/32 inches.

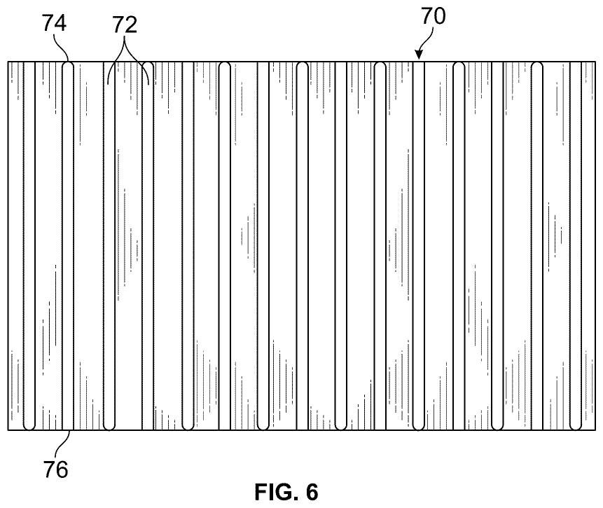

FIG. 6 illustrates an example inner absorbent material layer 70 that may be used to make towels or pads as disclosed above. In this example, one or both of the upper and lower surface of the inner absorbent material layer 70 comprises surface features in the form of one or more grooves or channels 72 that are recessed a partial depth therein rather than openings that extend completely through the inner absorbent material layer as disclosed and illustrated in the earlier examples. In an example, there may be a plurality of grooves or channels, and the plurality of grooves or channels may be oriented in the same or different direction along one or both surfaces of inner absorbent material layer. In an example, the grooves 72 may have a rounded or semicircular shape that is concave relative to the surface of the inner absorbent material layer. In an example, the grooves may operate to increase the surface area of the inner absorbent material layer to thereby increase water capture. In the example illustrated, each groove or channel 72 is configured having a closed end 74 and an opposed open end 76, and the grooves or channels are oriented so that the close end 74 of one groove is positioned next to an open end of an adjacent groove. In an example, this groove configuration and mixed orientation is believed to help provide an equalized or balanced controlled water collection and removal from the towel or pad during use.

In an example, the grooves 72 may operate to assist in directing water into or out of the towel when being used during drying or dewetting operation. In an example, during the lamination process used to make the towels or pads described above, the grooves may be filled and bonded with an upper and/or lower material layer, or the grooves may be open with the upper and/or lower material layer covering over a top portion of the channels. While FIG. 6 illustrates an example of the inner absorbent material layer comprising a particular configuration and arrangement of grooves or channels, it is to be understood that that is for purposes of reference and that any grooves or channels as used with the inner absorbent material layer may be configured, sized, shaped, oriented, and/or numbered differently than as illustrated and that all such variations of the same are understood to be within the scope of towels or pads as disclosed herein.

A feature of the towel or pad construction as disclosed herein is that it specifically engineered having a three-layer laminate construction that provide outer material layers that are specially configured to reduce or eliminate the possibility of scratching the surface of an object, e.g., such as a vehicle having a painted finish) when being used to remove liquid therefrom by pulling any dirt or debris inwardly into the fibers of the towel and away from the surface. Further, the presence of the inner absorbent material layer in the towel or pad construction operates to increase the amount or volume of liquid that may be removed from the surface of the object, thereby increasing use efficiency by reducing the amount of time and/or labor associated with the task of removing liquid from the object surface.

Although a few example embodiments of towel or pad constructions have been described in detail above, those skilled in the art will readily appreciate that many modifications are possible in the example embodiments without materially departing from the scope of the claims and present disclosure, and that all such modifications are understood to be within the scope of the towel or pad constructions as disclosed herein. Likewise, while the disclosure herein contains many specifics, these specifics should not be construed as limiting the scope of the disclosure or of any of the appended claims, but merely as providing information pertinent to one or more specific embodiments that may fall within the scope of the disclosure and the appended claims. Any described features from the various embodiments disclosed may be employed in combination.

In the description herein, various relational terms may be used to facilitate an understanding of various aspects of some embodiments of the present disclosure. Relational terms such as “upper,” “lower,” “top,” “bottom,” “above,” “below,” “left,” “right,” and the like may be used to describe various components, including their operational or illustrated position relative to one or more other components. Relational terms do not indicate a particular orientation for each embodiment within the scope of the description or claims, but are intended for convenience in facilitating reference to various components. Thus, such relational aspects may be reversed, flipped, rotated, moved in space, placed in a diagonal orientation or position, placed horizontally or vertically, or similarly modified.

Certain descriptions or designations of components as “first,” “second,” “third,” and the like can be used in the description or claims to differentiate between identical components or between components which are similar in use, structure, or operation. Such language is not intended to limit a component to a singular designation or require multiple components. As such, a component referenced in the specification as the “first” component may be the same or different than a component that is referenced in the claims as a “first” component, and a claim may include a “first”component without requiring the existence of a “second”component.

Furthermore, while the description or claims may refer to “an additional” or “other” element, feature, aspect, component, or the like, it does not preclude there being a single element, or more than one, of the additional element. Where the claims or description refer to “a” or “an” element, such reference is not be construed that there is just one of that element, but is instead to be inclusive of other components and understood as “at least one” of the element. It is to be understood that where the specification states that a component, feature, structure, function, or characteristic “may,” “might,” “can,” or “could” be included, that particular component, feature, structure, or characteristic is provided in certain embodiments, but is optional for other embodiments of the present disclosure. The terms “couple,” “coupled,” “connect,” “connection,” “connected,” “in connection with,” and “connecting” refer to “in direct connection with,” or “in connection with via one or more intermediate elements or members. ” Components that are “integral” or “integrally” formed include components made from the same piece of material, or sets of materials, such as by being commonly molded or cast from the same material, in the same molding or casting process, or commonly machined from the same piece of material stock. Components that are “integral”should also be understood to be “coupled”together.

Additionally, it should be understood that references to “one embodiment,” “an embodiment,” or “an example” of the present disclosure are not intended to be interpreted as excluding the existence of additional embodiments or examples that also incorporate the recited features on one form or another. For example, any element described in relation to an embodiment herein may be combinable with any element of any other embodiment described herein.

Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

What is claimed is:

1. A drying towel construction comprising:
an upper outer material layer formed from a fiber-containing material;
an inner absorbent material layer, wherein the upper outer material layer is adhered to an upper surface of the inner absorbent material layer, and wherein the inner absorbent material layer comprises one or more surface features disposed therein; and
a lower outer material layer formed from a fiber-containing material and adhered to a lower surface of the inner absorbent material layer.

2. The drying towel of claim 1, wherein an entirety of the inner absorbent material layer upper and lower surface is covered by the respective upper and lower material layers encapsulating the inner absorbent material layer therebetween.

3. The drying towel of claim 1, comprising an adhesive material interposed between the upper and lower inner absorbent material layer and the respective upper and lower material layers, wherein the adhesive material is used to adhere the upper and lower material layers to the inner adhesive material layer and form a laminate construction.

4. The drying towel of claim 1, wherein the one or more surface features comprises one or more openings extending through the inner absorbent material layer.

5. The drying towel of claim 4, wherein the inner absorbent material layer comprises a plurality of openings.

6. The drying towel of claim 5, wherein the plurality of openings extend across a partial width and a partial length of the inner absorbent material layer.

7. The drying towel of claim 4, wherein the openings are rectangular in shape.

8. The drying towel of claim 1, wherein the one or more surface features comprises one or more grooves that extend inwardly a partial depth into at least one of the upper surface or the lower surface of the inner absorbent material layer.

9. The drying towel of claim 1, comprising an edging material that is attached along a peripheral edge of the drying towel and the covers peripheral ends of the upper and lower outer material layers.

10. The drying towel of claim 1, wherein the inner absorbent material layer is formed from a chamois material that is natural or synthetic.

11. A laminate drying towel construction comprising:
an upper outer material layer and a lower outer material layer each formed from a fiber-containing material; and
an inner absorbent material layer that is interposed between and adhered to both the upper and lower outer material layers, wherein an entirety of the inner absorbent material is sandwiched between the upper and outer material layers, and wherein the inner absorbent material layer comprises a plurality of openings extending therethrough.

12. The laminate drying towel construction of claim 11, comprising an adhesive material interposed between the inner absorbent material layer and the upper and lower outer material layers that forms a bonded laminate construction.

13. The laminate drying towel construction of claim 11, wherein the plurality of openings are positioned across a partial length and partial width of inner absorbent material layer.

14. The laminate drying towel construction of claim 13, wherein the plurality of openings are arranged in an ordered pattern along the inner absorbent material layer.

15. The laminate drying towel construction of claim 13, wherein the openings are rectangular in shape.

16. A method for making a laminate drying towel construction comprising the steps of:
depositing an adhesive material onto opposed surfaces of an inner absorbent material layer;
moving the inner adhesive material towards opposed upper and lower nip rollers;
dispensing an upper outer material layer to the upper nip roller and compressing the upper outer material layer into contact with an upper surface of the inner absorbent material layer; and
dispensing a lower outer material layer to the lower nip roller and compressing the lower outer material layer into contact with a lower surface of the inner absorbent material layer thereby forming the composite construction;
wherein the inner absorbent material is completely covered by the upper and lower outer material layers, and wherein the inner absorbent material comprises one or more surface features therein that is covered by the one or both of the upper and lower outer material layers.

17. The method of claim 16, wherein the step of compressing the upper and lower outer material layers into contact with respective upper and lower surfaces of the inner absorbent material layer takes place at a heated temperature condition.

18. The method of claim 16, wherein the surface features comprise one or more openings through the inner absorbent material layer.

19. The method of claim 16, further comprising attaching an edging material to peripheral edges of the composite construction to cover the ends of the upper and lower outer material layers.

20. The method of claim 16, wherein during the step of depositing, the adhesive material is applied to a substantial entirety of the opposed surfaces of the inner absorbent material layer.
